(19) United States
(12) Patent Application Publication
(10) Pub. No.: US 2014/0263222 A1
(43) Pub. Date: Sep. 18, 2014

(54) LASER MACHINING DEVICE FOR MACHINING NETTED DOTS

(71) Applicant: HON HAI PRECISION INDUSTRY CO., LTD., New Taipei (TW)

(72) Inventor: YUNG-CHANG TSENG, New Taipei (TW)

(73) Assignee: HON HAI PRECISION INDUSTRY CO., LTD., New Taipei (TW)

(21) Appl. No.: 14/184,711

(22) Filed: Feb. 20, 2014

(30) Foreign Application Priority Data
Mar. 13, 2013 (TW) 102108923

(51) Int. Cl. B23K 26/00

(52) U.S. Cl. CPC B23K 26/0066
USPC 219/121.76

(57) ABSTRACT

An laser machining device for laser forming netted dots uses a metal grating to divide a polarized laser beam or an unpolarized laser beam into a penetrating laser beam and a reflected laser beam, and the cooperation of fixed reflecting mirrors and rotatable reflecting mirrors guides the penetrating laser beam and the reflected laser beam onto two or more predetermined positions on a workpiece.

### 1. FIELD

The present disclosure relates to optical systems, and particularly to a laser machining device for machining netted dots.

### 2. BACKGROUND

Laser machining devices are preferred for use in dot-pattern-formation on a bottom surface of a light guide plate. Laser beams emitted from the laser machining device are projected onto a bottom surface of a substrate to form a netted dot. However, if size of the light guide plate is large, the number of the netted dots will be great. Accordingly, the forming of the netted dots using the laser machining device takes a long time.

### BRIEF DESCRIPTION OF THE DRAWINGS

FIG. 1 is a schematic view of a first exemplary embodiment of a laser machining device for machining netted dots, showing the laser machining device machining netted dots on a light guide plate.

FIG. 2 shows a light path of unpolarized laser beam entering a metal grating of the laser machining device of FIG. 1.

FIG. 3 shows a light path of polarized laser beam entering a metal grating of the laser machining device of FIG. 1.

FIG. 4 is a schematic view of a second exemplary embodiment of a laser machining device for machining netted dots, showing the laser machining device machining netted dots on a light guide plate.

### DETAILED DESCRIPTION

FIG. 1 shows a first exemplary embodiment of a laser machining device 100 for machining netted dots on a processing surface 901 of a workpiece 900. The laser machining device 100 includes a laser light source 10, a metal grating 20, a first reflecting unit 110, and a second reflecting unit 120. In this embodiment, the workpiece 900 is made of plastic, such as polymethylmethacrylate (PMMA).

The laser light source 10 is configured to emit laser beam. The laser beam emitted from the laser light source 10 may be polarized or unpolarized. A polarizing mirror or other polarizing device can be used in a light chamber of the laser light source 10 to produce the laser beam with desired polarized direction. The energy and wavelength of the laser beam can be determined by a desired size and desired depth of each of the netted dots. In this embodiment, the laser beam is infrared light, which can easily be absorbed by plastic to form netted dots on the processing surface 901, and does not penetrate the workpiece 900.

FIG. 2 shows that, the metal grating 20 faces the laser light source. The metal grating 20 includes a substrate 201 and a number of metal strips 202. The substrate 201 is substantially cuboid and includes a first surface 204 and a second surface 206. The first surface 204 and the second surface 206 are located on opposite sides of the substrate 201. The first surface 204 is substantially parallel to the second surface 206. The second surface 206 faces the laser light source. The metal strips 202 are arranged periodically on the second surface 206 and are parallel to each other. An arrangement period of the metal strips 202 is less than half of the wavelength of the laser beam. Thus, laser beams pass through the metal grating 20 or are reflected by the metal grating 20, but diffraction of the laser beams is avoid. A splitting axis of the metal grating 20 is represented as 250, each of the metal strips 202 extends along the splitting axis 250.

When the laser beam is unpolarized laser beam 260, the metal strips 202 can be arranged along any direction on the second surface 206. The unpolarized laser beam 260 and a normal 270 of the second surface 206 cooperatively define an imaginary incident surface 280. A part of the unpolarized laser beam 260 is reflected by the metal grating 20 to form reflected laser beam 262. The reflected laser beam 262 is polarized light beam with polarized direction 263. The polarized direction 263 is substantially perpendicular to the imaginary incident surface 280. The rest of the unpolarized laser beam 260 penetrates the metal grating 20 to form penetrating laser beam 264. The penetrating laser beam 264 is polarized light beam with polarized direction 265. The polarized direction 265 is substantially parallel to the imaginary incident surface 280. The energy of the reflected laser beam 262 is substantially equal to the energy of the penetrating laser beam 264.

FIG. 3 shows that, when the laser beam is a polarized laser beam 360 having a polarized direction 369. The polarized laser beam 360 and the normal 270 of the second surface cooperatively define an imaginary incident surface 380. A part of the polarized laser beam 360 is reflected by the metal grating 20 to form reflected laser beam 362. The reflected laser beam 362 is polarized light beam with polarized direction 363. The polarized direction 363 is substantially perpendicular to the imaginary incident surface 380. The rest of the polarized laser beam 360 penetrates the metal grating 20 to form penetrating laser beam 364. The penetrating laser beam 364 is polarized light beam with polarized direction 365. The polarized direction 365 is substantially parallel to the imaginary incident surface 380. An angle θ between the splitting axis 250 and the polarized direction 369 is substantially about 45 degrees. If energy of the polarized laser beam 360 is I, then the energy of the penetrating laser beam 364 is I×cos(θ)², and the energy of the reflected laser beam 362 is I×sin(θ)². As the angle θ is substantially about 45 degrees, the energy of each of the penetrating laser beam 364 and the reflected laser beam 362 are both 0.5 I.

FIG. 1 shows that, the first reflecting unit 110 is configured to receive and reflect the reflected laser beam from the metal grating 20 to a first predetermined position on the processing surface 901 of the workpiece 900. The first reflecting unit 110 includes a first fixed reflecting mirror 30 and a first rotatable reflecting mirror 40. The first fixed reflecting mirror 30 is fixed in a path of the light reflected from the metal grating 20. The first fixed reflecting mirror 30 receives and reflects the reflected laser beam from the metal grating 20 onto the first rotatable reflecting mirror 40. The first rotatable reflecting mirror 40 is arranged in a path of the light reflected from the first fixed reflecting mirror 30. The first rotatable reflecting mirror 40 receives and reflects the reflected laser beam from the first fixed reflecting mirror 30 onto the first predetermined position. In particular, the first rotatable reflecting mirror 40 is positioned on a rotatable device 41 such that the first rotatable reflecting mirror 40 can be precisely rotated by the rotatable device 41.

The second reflecting unit 120 is configured to receive and reflect the penetrating laser beam from the metal grating 20 to a second predetermined position on the processing surface 901 of the workpiece 900. The second reflecting unit 120 includes a second fixed reflecting mirror 50, a third fixed reflecting mirror 60, and a second rotatable reflecting mirror 70. The second fixed reflecting mirror 50 is fixed in a path of the light penetrating from the metal grating 20. The second fixed reflecting mirror 50 receives and reflects the penetrating laser beam from the metal grating 20 onto the third fixed reflecting mirror 60. The third fixed reflecting mirror 60 receives and reflects the penetrating laser beam reflected from the second fixed reflecting mirror 50. The second rotatable reflecting mirror 70 is arranged in a path of the light reflected from the third fixed reflecting mirror 60. The second rotatable reflecting mirror 70 receives and reflects the penetrating laser beam reflected from the third reflecting mirror 60 onto the second predetermined position. In the embodiment, the second rotatable reflecting mirror 70 is positioned on a rotatable device 71 such that the second rotatable reflecting mirror 70 can be precisely rotated by the rotatable device 71. In the illustrated embodiment, the first fixed reflecting mirror 30 and the third fixed reflecting mirror 60 are arranged on opposite sides of a same horizontal plane. In other words, a distance between the first fixed reflecting mirror 30 and the processing surface 901 is substantially equal to a distance between the third fixed reflecting mirror 60 and the processing surface 901. The first rotatable reflecting mirror 40 and the second rotatable reflecting mirror 70 are arranged on opposite sides of a same horizontal plane. In other words, a distance between the first rotatable reflecting mirror 40 and the processing surface 901 is substantially equal to a distance between the second rotatable reflecting mirror 70 and the processing surface 901.

The laser beam projected onto the workpiece 900 machines netted dots 902 on the processing surface 901, so as to form a light guide plate.

FIG. 4 shows a second exemplary embodiment of a laser machining device 200 for machining netted dots on a processing surface 801 of a workpiece 800. The laser machining device 200 includes a laser light source 15, a metal grating 25, a first reflecting unit 210, and a second reflecting unit 220.

The laser light source 15 has the same characteristics as the laser light source 10 detailed in the first embodiment of this disclosure, as shown in FIG. 1. The metal grating 25 has the same characteristics with the metal grating 20 detailed in the first embodiment, as shown in FIG. 1.

The first reflecting unit 210 is configured to receive and reflect the reflected laser beam from the metal grating 25 to a first predetermined position on the processing surface 801 of the workpiece 800. The first reflecting unit 210 includes a first fixed reflecting mirror 35 and a first rotatable reflecting mirror 45. The first fixed reflecting mirror 35 is fixed in a path of the light reflected from the metal grating 25. The first fixed reflecting mirror 35 receives and reflects the reflected laser beam from the metal grating 25 onto the first rotatable reflecting mirror 45. The first rotatable reflecting mirror 45 is arranged in a path of the light reflected from the first fixed reflecting mirror 35. The first rotatable reflecting mirror 45 receives and reflects the reflected laser beam from the first fixed reflecting mirror 35 onto the first predetermined position. In particular, the first rotatable reflecting mirror 45 is positioned on a rotatable device 42 such that the first rotatable reflecting mirror 45 can be precisely rotated by the rotatable device 42.

The second reflecting unit 220 is configured to receive and reflect the penetrating laser beam from the metal grating 25 to a second predetermined position on the processing surface 801 of the workpiece 800. The second reflecting unit 220 includes a second rotatable reflecting mirror 55. The second rotatable reflecting mirror 55 is arranged in a path of the light penetrating from the metal grating 25. The second rotatable reflecting mirror 55 receives and reflects the penetrating laser beam from the metal grating 25 onto the second predetermined position. In particular, the second rotatable reflecting mirror 55 is positioned on a rotatable device 52 such that the second rotatable reflecting mirror 55 can be precisely rotated by the rotatable device 52.

The above-described laser machining devices use the metal grating to divide the polarized laser beam or the unpolarized laser beam into the penetrating laser beam and the reflected laser beam, and the cooperation of the fixed reflecting mirrors and the rotatable reflecting mirrors guides the penetrating laser beam and the reflected laser beam onto two or more predetermined positions on the workpiece. In this way, a timesaving of at least fifty percent can be made for forming the netted dots.

Although numerous characteristics and advantages of the present embodiments have been set forth in the foregoing description, together with details of the structures and functions of the embodiments, the disclosure is illustrative only, and changes may be made in detail, especially in the matters of shape, size, and the arrangement of parts within the principles of the disclosure to the full extent indicated by the broad general meaning of the terms in which the appended claims are expressed.

What is claimed is:

1. A laser machining device for laser forming netted dots on a workpiece, the laser machining device comprising:
a laser light source for emitting laser beam, the laser beam is one of unpolarized laser beam or polarized laser beam having a polarized direction;
a metal grating facing the laser light source, the metal grating configured for dividing the laser beam into penetrating laser beam and reflected laser beam with same energy, the metal grating comprises a substrate and a number of metal strips periodically and parallelly arranged on the substrate, if the laser beam is the unpolarized laser beam, the metal strips can be arranged along any direction, if the laser beam is the polarized laser beam with a polarized direction, a splitting axis of the metal grating deviating the polarized direction 45 degrees;
a first reflecting unit configured for reflecting the reflected laser beam to a first predetermined position of the workpiece; and
a second reflecting unit configured for reflecting the penetrating laser beam to a second predetermined position of the workpiece.

2. The laser machining device of claim 1, wherein the laser machining device is configured for laser forming netted dots on a workpiece made of plastic.

3. The laser machining device of claim 2, wherein the laser beam is infrared light.

4. The laser machining device of claim 1, wherein an arrangement period of the metal strips is less than the wavelength of the laser beam emitted from the laser light source.

5. The laser machining device of claim 4, wherein the first reflecting unit comprise a first fixed reflecting mirror and a first rotatable reflecting mirror, the first fixed reflecting mirror receives and reflects the reflected laser beam from the metal grating onto the first rotatable reflecting mirror, the first rotatable reflecting mirror receives and reflects the reflected laser beam from the first fixed reflecting mirror onto the first predetermined position of the workpiece.

6. The laser machining device of claim 5, wherein the second reflecting unit comprises a second fixed reflecting mirror, a third fixed reflecting mirror, and a second rotatable reflecting mirror, the second fixed reflecting mirror receives and reflects the penetrating laser beam from the metal grating onto the third fixed reflecting mirror, the third fixed reflecting mirror receives and reflects the penetrating laser beam reflected from the second fixed reflecting mirror, the second rotatable reflecting mirror receives and penetrating laser beam reflected from the third reflecting mirror on the second predetermined position of the workpiece.

7. The laser machining device of claim 6, wherein the first rotatable reflecting mirror and the second rotatable reflecting mirror are respectively positioned on a rotatable device.

8. The laser machining device of claim 6, wherein a distance between the first fixed reflecting mirror and the workpiece is substantially equal to a distance between the third fixed reflecting mirror and the workpiece, and a distance between the first rotatable reflecting mirror and the workpiece is substantially equal to a distance between second rotatable reflecting mirror and the workpiece.

9. The laser machining device of claim 5, wherein the second reflecting unit only comprises second rotatable reflecting mirror, the second rotatable reflecting mirror receives and reflects the penetrating laser beam from the metal grating to the second predetermined position of the workpiece.

10. The laser machining device of claim 9, wherein the first rotatable reflecting mirror and the second rotatable reflecting mirror are respectively positioned on a rotatable device.
